(19) United States
(12) Patent Application Publication
(10) Pub. No.: US 2009/0139624 A1
(43) Pub. Date: Jun. 4, 2009

(54) Tube-shaped tubeless tire

(76) Inventor: Chin Ju Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,290

(22) Filed: Nov. 29, 2007

(51) Int. Cl. B60C 13/02

(52) U.S. Cl. 152/523

(57) ABSTRACT

A tube-shaped tubeless tire includes a tire body having two sidewalls and an inner surface, each of the two sidewalls being externally provided along a radially inner edge with an annular recess; a lining belt having two outer edges separately connected to the inner surface of the tire body, making the tire body a closed tube-shaped body; and a wheel rim being provided along two opposite annular outer edges with a laterally inward protruded annular rib each to face toward the annular recess on the sidewalls of the tire body. When pumping air into the tire body, the tire body and the lining belt are gradually expanded to push the annular recesses on the tire body against the annular ribs on the wheel rim, so that the tire body is completely held to the wheel rim.

### FIELD OF THE INVENTION

The present invention relates to a tire, and more particularly to an easily inflatable tube-shaped tubeless tire.

### BACKGROUND OF THE INVENTION

FIG. 1 shows a conventional tube-shaped tubeless tire, which includes a tire body 10 and a wheel rim 11. The tire body 10 has two opposite sidewalls 12. An annular recess 13 is provided near and along a radially inner edge of each of the two sidewalls 12. The wheel rim 11 is provided along two opposite annular outer edges with a laterally inward protruded rib 14 each to correspond to the annular recesses 13 on the tire body 10.

To inflate the tire body 10, air with high pressure must be pumped into the tire body 10 using an air pump usually provided only by a bicycle or motorcycle shop or a garage, so that the tire body 10 is expanded in volume to force the radially inner edges of the two sidewalls 12 laterally outward to engage with the annular ribs 14 on the wheel rim 11, enabling the tire body 10 to be held to the wheel rim 11.

In the event the tire body 10 is punctured by something pointed, the tire body 10 must be dismounted from the wheel rim 11 to seal the puncture before being mounted to the wheel rim 11 again. The re-mounted tire body 10 must be inflated. Generally speaking, a common portable inflator fails to provide sufficient air pressure to fully inflate the tubeless tire body 10. Therefore, the annular recesses 13 on the tire body 10 could not be engaged with the annular ribs on the wheel rim 11, and the rider or the driver can do nothing but try to send the bicycle/motorcycle or the car to a repair shop or garage to inflate the tire body 10.

### SUMMARY OF THE INVENTION

It is therefore a primary object of the present invention to provide an easily inflatable tube-shaped tubeless tire.

To achieve the above and other objects, the tube-shaped tubeless tire according to the present invention includes a tire body, an elastic lining belt, and a wheel rim. The tire body has two opposite sidewalls and an inner surface, each of the two sidewalls being externally provided near and along a radially inner edge with an annular recess. The lining belt has two opposite outer edges separately connected to the inner surface of the tire body, making the tire body a closed tube-shaped body. The wheel rim has two opposite annular outer edges, on and along each of which a laterally inward protruded annular rib is formed to face toward the annular recess on one corresponding sidewall of the tire body.

Whereby when air is pumped into the tire body via an inflation valve provided on the lining belt to inflate the tire body, the tire body is gradually expanded in volume with the pumping of air; meanwhile, the air pumped into the tire body also applies pressure against the lining belt to expand and stretch the lining belt. The expanded and stretched lining belt pushes the radially inner edges of the two sidewalls of the tire body to laterally move outward and force the annular recesses against and to finally engage with the inward protruded annular ribs on the wheel rim, so that the tire body is completely held to the wheel rim.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a cross sectional view of a conventional tubeless tire in an inflated state;

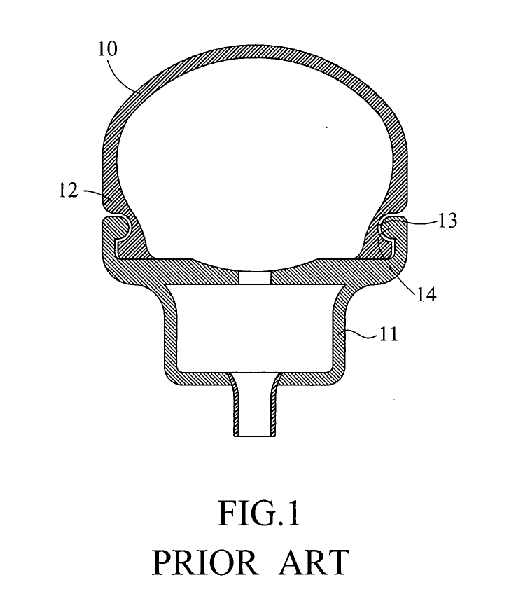

FIG. 2 is a perspective view of a tube-shaped tubeless tire according to an embodiment of the present invention;

FIG. 3 is a cross sectional view of the tubeless tire of the present invention before being inflated; and

FIG. 4 is a cross sectional view of the tubeless tire of the present invention in an inflated state.

### DETAILED DESCRIPTION OF THE PREFERRED EMBODIMENTS

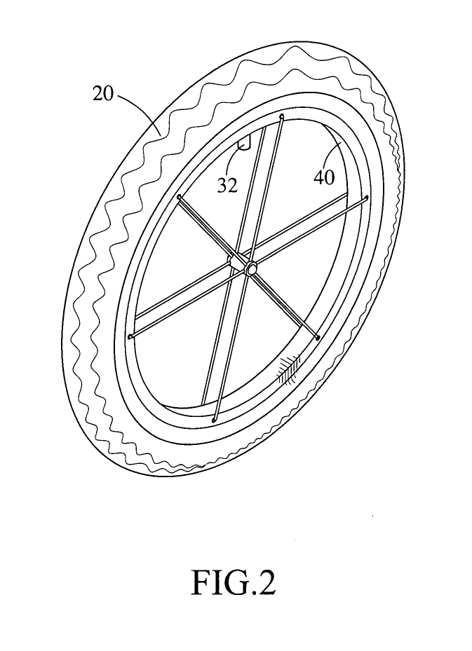

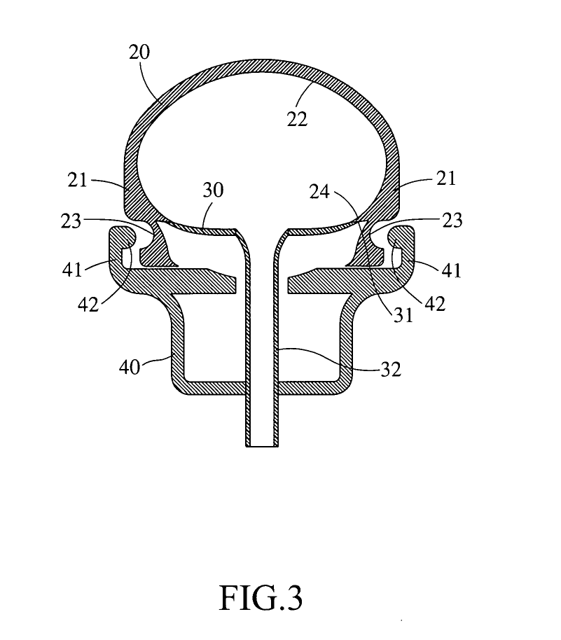

Please refer to FIG. 2 that is a perspective view of a tube-shaped tubeless tire according to an embodiment of the present invention, and to FIG. 3 that is a cross sectional view of the tubeless tire of the present invention before being inflated. As shown, the tube-shaped tubeless tire of the present invention includes a tire body 20, an elastic lining belt 30, and a wheel rim 40.

The tire body 20 has two opposite sidewalls 21 and an inner surface 22. Each of the sidewalls 21 is externally provided near and along a radially inner edge with an annular recess 23. The tire inner surface 23 is provided near and behind each annular recess 23 with an inward extended annular flange 24, which are integrally formed in the tire body 20.

The lining belt 30 has two opposite outer edges 31 separately connected to the annular flanges 24 in the tire body 20, making the tire body 20 a closed tube-shaped body. The lining belt 30 is provided at a predetermined position with an inflation valve 32, via which air may be pumped into the tire body 20.

The wheel rim 40 has two opposite annular outer edges 41, on and along each of which a laterally inward protruded annular rib 42 is formed to face toward the annular recess 23 on one corresponding sidewall 21 of the tire body 20.

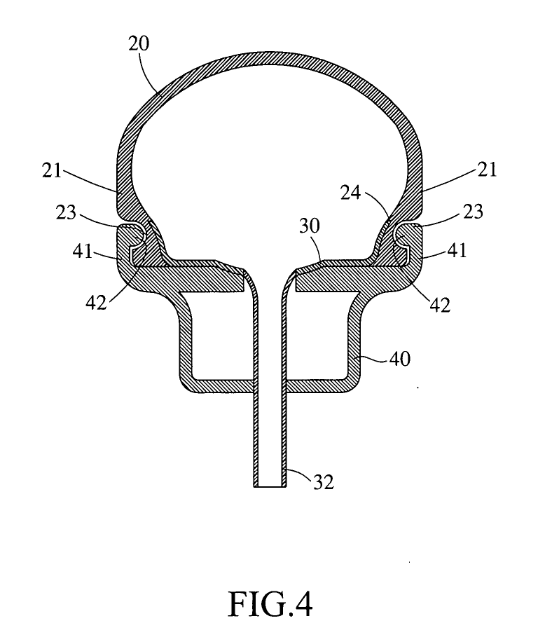

As shown in FIG. 4, when air is pumped into the tire body 20 via the inflation valve 32 to inflate the tire body 20, the tire body 20 is gradually expanded in volume with the pumping of air. The air pumped into the tire body 20 also applies pressure against the lining belt 30 to expand and stretch the lining belt 30, and the radially inner edges of the two sidewalls 21 of the tire body 20 are pushed by the expanded and stretched lining belt 30 to laterally move outward, forcing the annular recesses 23 against and to finally engage with the inward protruded annular ribs 42. At this point, the tire body 20 is completely held to the wheel rim 40.

In brief, the tire body 20 of the tubeless tire of the present invention is internally provided with a lining belt 30, which has two opposite annular outer edges connected to the tire inner surface 22 for the tire body 20 to form a closed tube-shaped body. In the event the tire body 20 is punctured by something pointed to form a hole, the tire body 20 may be easily repaired simply by sealing the hole with a tire patch and inflating the tire body 20 with a portable inflator until the tire body 20 is fully inflated to fitly engage with the wheel rim 40. That is, a user may complete the inflation of a punctured and deflated tubeless tire simply by using a general inflator.

The tube-shaped tubeless tire of the present invention may be widely applied in bicycles, automobiles, and motorcycles.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A tube-shaped tubeless tire, comprising:
a tire body having two opposite sidewalls and an inner surface, each of the two sidewalls being externally provided near and along a radially inner edge with an annular recess;
a lining belt having two opposite outer edges separately connected to the inner surface of the tire body, making the tire body a closed tube-shaped body; and
a wheel rim having two opposite annular outer edges, on and along each of which a laterally inward protruded annular rib being formed to face toward the annular recess on one corresponding sidewall of the tire body;
whereby when air is pumped into the tire body via the lining belt to inflate the tire body, the tire body is gradually expanded in volume with the pumping of air; meanwhile, the air pumped into the tire body also applies pressure against the lining belt to expand and stretch the lining belt, and the expanded and stretched lining belt pushes the radially inner edges of the two sidewalls of the tire body to laterally move outward and force the annular recesses on the sidewalls against and to finally engage with the inward protruded annular ribs on the wheel rim, so that the tire body is completely held to the wheel rim.

2. The tube-shaped tubeless tire as claimed in claim 1, wherein the tire inner surface is provided near and behind each of the annular recesses with an inward extended annular flange, such that the annular flanges are connected to the two outer edges of the lining belt.

3. The tube-shaped tubeless tire as claimed in claim 1, wherein the lining belt is provided at a predetermined position with an inflation valve, via which air is pumped into the tire body.
